(19) United States
(12) Patent Application Publication
(10) Pub. No.: US 2010/0068356 A1
(43) Pub. Date: Mar. 18, 2010

(54) Sweetener combination for sweetening canned fruit

(76) Inventor: Katrin SAELZER, Kahl am Main (DE)

Correspondence Address: PROPAT, L.L.C., 425-C SOUTH SHARON AMITY ROAD, CHARLOTTE, NC, 28211-2841, US

(21) Appl. No.: 12/581,683

(22) Filed: Oct. 19, 2009

Related U.S. Application Data
(63) Continuation-in-part of application No. 10/924,160, filed on Aug. 23, 2004, now abandoned.

(30) Foreign Application Priority Data
Oct. 16, 2003 (DE) 103 48 723.9

(51) Int. Cl. A23L 1/236

(52) U.S. Cl. 426/131; 426/548

(57) ABSTRACT

The invention relates to canned fruits containing a sweetener compositions formed acesulfame-K and sucralose in a weight ratio ranging from 70/30 to 98/2. In addition, the invention relates to processes for at least partially replacing sucrose (sugar) in canned fruit, and make-up solutions containing the inventive sweetener compositions.

### CROSS-REFERENCE TO RELATED APPLICATIONS

This application is a continuation-in-part of co-pending U.S. patent application Ser. No. 10/924,160, filed Aug. 23, 2004. Co-pending U.S. patent application Ser. No. 10/924,160 is hereby incorporated by reference in its entirety. This application further claims priority to its parent, German patent application no. 103 48 723.9 filed Oct. 16, 2003, hereby incorporated by reference herein in its entirety.

### FIELD OF THE INVENTION

The invention relates to a sweetener composition including acesulfame-K and sucralose in a weight ratio ranging from 70/30 to 98/2 for sweetening canned fruit. In addition, the invention relates to a process for at least partially replacing sucrose (sugar) in canned fruit.

### BACKGROUND OF THE INVENTION

Preserved fruit, more commonly referred to in United States markets as canned fruit, usually comprise between 10 and 25% by weight of sugar, but higher concentrations up to above 30% by weight can occasionally be reached. The sugar in canned fruit serves primarily for sweetening, but also to improve the aroma and fruitiness.

Because of the increased health consciousness of consumers, which is also reflected in their diet, there are efforts, firstly, directed toward increased consumption of fruit and vegetables, and secondly directed toward decreasing consumption of added sugar to reduce calorie intake.

The sometimes very high sugar content of fruit in canned fruit is therefore perceived disadvantageous by consumers, which has an adverse effect on consumption and thus the market of such products.

In addition to the high nutritional benefit of canned fruit, for consumers the good taste also plays a major role. A product which does not meet the taste and aroma expectations of the consumers will not be accepted either. Further decision criteria are the ready handling and sufficient storage stability of the products. This is approximately 3-4 years in the case of commercially produced canned fruit. Artificially sweetened products, such as artificially sweetened fruit spreads, are also known to suffer from textural defects, including poor mouthfeel, as described in U.S. Pat. No. 5,397,588 to Antenucci et al.

The market for sugar-free and thus reduced-calorie canned fruit is very limited to date, since either the taste quality or storage stability in the end product does not conform to the requirements of consumers.

Sweeteners for canned fruit used to-date are saccharin and cyclamate as individual sweetener or in combination, where both systems do not correspond to the taste requirements of consumers with respect to sweetness intensity and quality of the sweetness profile and fruitiness. A mixture of acesulfame K and aspartame is used for producing canned fruit but sufficiently long-term storage stability of the sweetness is not provided.

C. A. West [U.S. Pat. No. 2,536,970] in 1951 described the reduction of the unwanted off-taste and after-taste of saccharin-sweetened preserved fruit by combinations with pectin. H. W. Walker [U.S. Pat. No. 2,608,489] stated in 1952 that it is possible to enhance the taste of the sweet fruit products by a combination of saccharin with the sugar alcohol sorbitol and/or carboxymethyl cellulose. In this case sorbitol serves to enhance the sweet taste, carboxymethylcellulose is said to contribute to optimization of mouth feel.

None of these possibilities were actually used in the current market for canned fruit, since the taste qualities of such products clearly do not meet consumer expectation. J. B. Gordon [U.S. Pat. No. 2,629,655], in the case of the described mixtures of saccharin with pectin or sorbitol, still observed a metallic off-taste which adversely affected the overall impression of the product. As an alternative, a mixture of saccharin and cyclamate is proposed for sweetening canned fruit, which mixture, with respect to sweetness, is closer to the standard, sugar, than preserved fruit containing saccharin or one of the mixtures described above.

Anderson et al. [Journal of the American Dietetic Association, August 1953 (29), 770-773], however, describes differences between canned fruit sweetened with mixtures of saccharin and/or cyclamate compared with sugar and fruit in aqueous solution. For virtually all fruits, for example raspberries, sweet cherries, pears or rhubarb, the sugared samples were preferred. All sugar-free sweetening systems were only preferred to fruit in water.

It is known from various more recent studies in sugar-free and reduced-sugar drinks that some sweetening systems have a particularly sugar-like sweet taste and particularly show certain aromas to advantage [Meyer, World of Food Ingredients, Dec. 2000, 42-44], [Meyer, Soft Drink International, September 2001]. It was found that, especially, combinations of acesulfame-K and aspartame in mixing ratios of 30/70 to 50/50 (based on their sweetness contribution), i.e combinations containing far less to a maximum of equal amounts of acesulfame-K based on sweetness, give very good results with respect to the quality of sweetness and support of the aroma.

For canned fruit which are sweetened with aspartame alone or in a blend, with, for example, acesulfame-K, however, a storage life of only 12 to 18 months is possible [G. Frei, NUTRASWEET® and heat processing—product opportunities, 1990, anon., 155-160], but the shelf life of canned fruit should usually be 3 to 4 years. For use in canned fruit, stability of the sweetness of aspartame-containing mixtures after heating and storage over several years is therefore insufficient.

In contrast, it is known that the sweeteners acesulfame-K and also sucralose are stable under the abovementioned temperature conditions [Alternative Sweeteners, Editors Lyn O′Brien Nabors, Robert C. Gelardi, Calorie Control Council Atlanta, 2nd Edition 199]. Unfortunately, it is well known in the art that acesulfame-K has a bitter aftertaste, especially at high concentrations. In fact, acesulfame-K has been found to have a delayed bitter aftertaste that is more intense and longer in duration than sucrose, aspartame or alitame. [Ott, D. B., Edwards, C. G. and Palmer, S. J., Perceived Taste Intensity and Duration of Nutritive and Non-nutritive Sweeteners Using Time-Intensity Evaluations, J. Food Sci, 56 535-542 (1991).] Bitterness inhibitors for acesulfame-K, such as cinnamic acid derivatives, are described in U.S. Pat. No. 5,336,513. The incorporation of such bitterness inhibitors increase the cost and complexity of the resulting product, however.

It is known from the abovementioned studies that mixtures of acesulfame-K and sucralose in drinks in sweetness ratios of about 20/80 or 30/70, which is equivalent to a weight fraction of 45/65 or 55/45, have a very sugar-like sweetness and a pleasant sweetness profile as given, for example, by combinations in the sweetness ratio acesulfame-K/sucralose around 50/50, which is equivalent to the weight ratio of 75/25. (The foregoing difference between values for sweetness ratios and weight ratios is due to the fact that sucralose has a greater sweetness intensity than acesulfame-K. Acesulfame-K is known to have a sweetness which is 200 times the sweetness of sugar, while sucralose is known to have 600 times the sweetness of sugar. Sucralose is thus 3 times sweeter than acesulfame-K).

Other recommendations [Splenda Inc 2001, Splenda Brand Sweetener in soft drinks, product booklet] describe, as optimum-tasting mixing ratios for acesulfame-K and sucralose in drinks and foods, mixtures in which the weight fraction of the sucralose in the mixture is high, that is to say the ratio of the two sweeteners to one another is shifted toward sucralose, presumably to compensate for the bitter aftertaste of acesulfame-K.

Comparable concepts for canned fruit which in addition meet the high storage time of preserved fruit, are unknown, in contrast.

### SUMMARY OF ADVANTAGEOUS EMBODIMENTS OF THE INVENTION

It is therefore an object of the present invention to provide a sweetener design which meets all of the following conditions:
1) sugar reduction and thus calorie reduction compared with conventionally sugared canned fruit,
2) stability of the sweetness even after heating and storage of the canned over several years.
3) taste improvement of previous sugar-free preserved fruit toward a very sugar-like sweetness and good support of the fruit aroma.

This object is achieved by using a more elevated amount of acesulfame-K in combination with sucralose for sweetening reduced-sugar or sugar-free preserved fruit. The advantageous taste and aroma profile produced by the inventive blend containing substantially more acesulfame-K than sucralose was altogether unexpected, given the known bitter aftertaste of acesulfame-K at high concentrations.

### BRIEF DESCRIPTION OF THE DRAWINGS

FIG. 1 is a graphical illustration of the results of a triangle test of Acesulfame-K/sucralose versus sucrose.

### DETAILED DESCRIPTION OF ADVANTAGEOUS EMBODIMENTS OF THE INVENTION

Thus it has surprisingly been found that, in canned fruit, mixtures of acesulfame-K and sucralose, especially in a sweetness ratio of about 50/50, this is equivalent to weight ratios of acesulfame-K to sucralose of about 75/25, such as a weight ratio ranging from 70/30 to 98/2, preferably from 80/20 to 98/2, more preferably from 85/15 to 97/3, and even more preferably from 90/10 to 96/4, give a preferred sweetness profile, i.e. a taste profile comparable to that of sugar, and imparts a full fruit aroma to the canned fruit.

This is particularly surprising to the extent that in previous sugar-free drinks and food mixtures of acesulfame-K and sucralose having a higher sucralose content (greater than 50% sweetness fraction or greater than 25% by weight) always caused a particularly sugar-like sweet taste, and was thus preferred. In canned fruit, however, better-tasting products are obtained when the familiar ratios are reversed and the sweetness contribution of acesulfame-K in the sweetener mixture predominates. As noted above, such a result is altogether unexpected in light of the known bitter aftertaste of acesulfame-K.

It has further been found that canned fruit which are sweetened with inventive mixtures of acesulfame-K and sucralose, owing to the more pleasant sweetness and the fuller fruit aroma, are preferred to previously customary canned fruit sweetened with saccharin and cyclamate.

The inventive use of sweetener mixtures can be employed, for example, in the form that the sweeteners or the sweetener mixture are added directly to the canned fruit or by using solutions of the sweeteners or sweetener mixture as make-up liquid for the canned fruit. This make-up liquid can also be present in concentrated form and be diluted appropriately by further addition of water.

Alternatively to the inventive sweetener acesulfame-K, use can be made of other salts of acesulfamic acid, and also of the free acid itself. A possible preparation of acesulfame-K is, for example, the SO₃ process, which is described in EP-A-0 155 634. By varying the neutralization base, various acesulfame salts can be prepared.

Fruit varieties which are suitable are all varieties which can be processed to preserves, for example pears, peaches, cherries, but also citrus fruits, including mandarins, oranges, and also tropical fruits such as pineapples, mango, lychee and various berries. The fruit varieties can be used individually or in combination as a fruit cocktail or fruit mixture.

The processing conditions of the preserved fruit correspond to the production processes customary for comparable sugared products. This comprises first washing and if appropriate comminution of the fruits, then the addition of the sweetened make-up solution. Then heating is performed preferably in the closed package which can consist of glass, metal or plastic, to ensure the keeping quality of the fruit. The temperatures and heating times required for this can vary within wide ranges depending on the size and package and also processes used.

According to the invention, the sweeteners in canned fruits are expediently used in mixing ratios of acesulfame-K/sucralose of at least 70/30% by weight, such as from 80/20% by weight to 98/2% by weight, preferably in amounts of 85/15% by weight up to 97/3% by weight, and particularly preferably in amounts of 90/10% by weight up to 96/4% by weight (in each case always based on the total mass of the sweetener mixture).

As weight fraction of the inventive mixture of the initial weight of the total preserved fruit, depending on the desired sweetness intensity in the end product, preferably 0.005% by weight to 0.1% by weight is used, particularly preferably 0.015% by weight to 0.065% by weight.

Furthermore, in inventive preserved fruits, in addition to high-intensity sweeteners, various types of sugar (caloric sweeteners) can be present, for example sucrose, glucose, fructose in differing amounts. Since the natural sugar content in canned fruits is dependent on the mixing ratio of the fruit to the make-up solution and also on the sugar content of the fruits, which is subjected to great variations depending on the fruit variety, season or region of cultivation, the content of caloric sweeteners can vary within broad limits. Added sugars can also be present in addition to the high-intensity sweeteners.

Furthermore, use can be made of small amounts of other sweeteners, for example cyclamate, saccharin, NHDC or others for flavor rounding and intensification of a defined aroma impression in the case of particular fruit varieties or fruit mixtures. The amounts required of these substances are in the range of up to 0.06% by weight, based on the total end product, depending on the taste intensity of the added substance.

Likewise, other ingredients can be added to the preserved fruits in concentrations known to those skilled in the art, for example acids (inter alia citric acid) for pH adjustment, antioxidants (such as ascorbic acid) to prevent browning reactions, dyes or aroma substances. Thickeners may be used to adapt the viscosity of the make-up solution. As known in the art, thickeners increase the viscosity of the canned fruit make-up solution, but do not form an internal structure, as do gelling agents. Exemplary thickeners include one or more of polysaccharides, such as starches, or proteins. Exemplary starches include one or more of arrowroot, cornstarch, katakuri starch, potato starch, sago and tapioca. Exemplary vegetable gum thickeners include one or more of alginin, and xanthan gum. Exemplary protein food thickeners include one or more of collagen, egg whites, furcellaran and gelatin. The thickener is present within the canned fruit make-up solution in an amount effective to impart sufficient viscosity, but not to form an internal structure such as a gel. Depending on additive and purpose, the customary concentration in use can vary around 0.01 to 1% by weight in the entire product.

The invention further relates to a process for the partial or complete sugar replacement in canned fruits. In this case a portion up to the entire amount of the customarily added sugar in the preserved fruit is replaced by the inventive acesulfame-K/sucralose mixture.

The invention will be described in more detail below on the basis of examples.

### Comparative Example

### Preserved Pears Having Differing Acesulfame-K/Sucralose Ratios

Canned pears were produced in accordance with the recipes specified in table 1. For this the pears were first peeled, chopped and treated with ascorbic acid solution (0.5% by weight) to prevent browning without significantly affecting the sweetness or aroma of the resulting canned fruit. The fruit was covered with hot make-up solution at 90° C. and then heated for a further 10 min at 90° C. in closed vessels. After cooling, the preserved fruit were stored for a plurality of weeks at room temperature (no controlled conditions) thereafter described in sensory terms by experienced panelists.

TABLE 1

| | Mixing ratios acesulfame-K to | | |
|---|---|---|---|
| | sucralose (sweetness ratio) | | |
| | 20/80 | 50/50 | Sugar |
| Pears | 100 g | 100 g | 100 g |
| Make-up | 100 ml | 100 ml | 100 ml |
| solution | | | |
| consisting of: | | | |
| acesulfame-K | 0.02 g/100 ml | 0.05 g/100 ml | — |
| Sucralose | 0.032 g/100 ml | 0.02 g/100 ml | — |
| Sugar | — | — | 27 g/100 ml |
| ascorbic acid | 0.1 g/100 ml | 0.1 g/100 ml | 0.1 g/100 ml |
| Taste | little pear taste, | little pear aroma, | sweet pear, |
| description | sweetness | sweetness intensity | round, full |
| | intensity | ok, long-persisting | sweetness |
| | corresponds to the | sweet aftertaste | |
| | comparison sugar, | | |
| | but long-persisting | | |
| | sweetness, | | |
| | licorice-like, sweet | | |
| | aftertaste | | |

(Note: Analytically detectable concentrations of added sweeteners in the end product are significantly lower, since complete concentration exchange between fruit and solution takes place. In the table, concentrations of sweeteners are reported in relation to the make-up solution. Also, the sweetness ratio of the 20/80 acesulfame-K/sucralose sample converts to 38.5/61.5 weight ratio, while the sweetness ratio of the 50/50 sample converts to a 71.4/28.6 weight ratio.)

As the results show, none of the recipes tested fully achieved the taste qualities of sugar. The sweetness profile deviates from sugar, this also adversely influences the expression of the full fruit aroma.

### Example 1

Preserved pears were produced in a similar manner to the comparative example, but the recipes according to table 2 were used.

TABLE 2

| | Mixing ratios acesulfame-K to | | |
|---|---|---|---|
| | sucralose (sweetness distribution) | | |
| | 80/20 | 90/10 | |
| | (sweetness ratio) | (sweetness ratio) | Sugar |
| Pears | 100 g | 100 g | 100 g |
| Make-up | 100 ml | 100 ml | 100 ml |
| solution | | | |
| consisting of: | | | |
| acesulfame-K | 0.066 g/100 ml | 0.0743 g/100 ml | — |
| Sucralose | 0.007 g/100 ml | 0.0035 g/100 ml | — |
| Sugar | — | — | 17 g/100 ml |
| ascorbic acid | 0.1 g/100 ml | 0.1 g/100 ml | 0.1 g/100 ml |
| Taste | Typical pear | typical pear aroma, | typical of pears, |
| description | aroma, same | rapid onset of | round sweetness, |
| | sweetness | sweetness, very | pleasant |
| | intensity, | sugar-like, no off- | sweetness |
| | sweetness onset as | taste | intensity |
| | sugar, persistent | | |
| | sweetness | | |

As may be seen, surprisingly better results were achieved with the novel mixing ratios. The sweetness profile of the mixtures 80/20 and 90/10 are comparable to the sweetness profile of sugar. Also, both sugar-free variants corresponded to the sugared ones with respect to fruitiness. The acesulfame-K/sucralose sweetness ratio 80/20 converts to a 90.4/9.6 weight ratio and the acesulfame-K/sucralose sweetness ratio of 90/10 converts to a 95.5/4.5 weight ratio.

### Example 2

### Preserved Pears Sweetened with Acesulfame-K and Sucralose can No Longer be Differentiated from Sugar

In a similar manner to the comparative example, preserved pears were produced, table 3 shows the concentrations used.

TABLE 3

| | Acesulfame-K/sucralose | |
|---|---|---|
| | 80/20 (sweetness ratio) | Sugar |
| Pears | 100 g | 100 g |
| Make-up solution | 100 ml | 100 ml |
| consisting of: | | |
| acesulfame-K | 0.066 g/100 ml | — |
| Sucralose | 0.007 g/100 ml | — |
| Sugar | — | 17 g/100 ml |
| ascorbic acid | 0.1 g/100 ml | 0.1 g/100 ml |

These samples were tested by 12 people in a triangle test. In this test, three samples, coded and in random sequence, were served to each tester; of the samples two were the same and one different. The different sample had to be identified. Only 4 of the testers correctly reported the different sample. Statistically, this does not represent a significant difference, since the probability that such a result would be obtained by chance is virtually 93%. The samples, therefore, cannot be separated from one another.

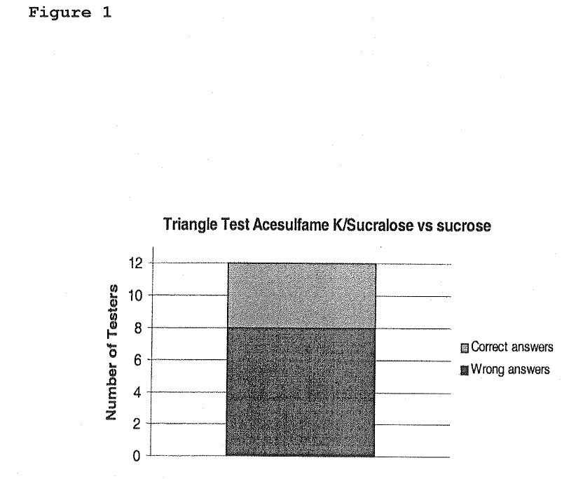

FIG. 1 illustrates the results.

### Example 3

### Preserved Pears Containing Acesulfame-K and Sucralose are Preferred to Comparable Products Containing Saccharin/Cyclamate

In a similar manner to the comparative example, preserved pears were produced and tasted, table 4 gives the concentrations used.

TABLE 4

| | Acesulfame-K/sucralose | |
|---|---|---|
| | 80/20 (sweetness ratio) | Saccharin/cyclamate |
| Pears | 100 g | 100 g |
| Make-up solution | 100 ml | 100 ml |
| consisting of: | | |
| acesulfame-K | 0.066 g/100 ml | — |
| Saccharin | — | 0.012 g/100 ml |
| Sucralose | 0.007 g/100 ml | — |
| Cyclamate | — | 0.112 g/100 ml |
| ascorbic acid | 0.1 g/100 ml | 0.1 g/100 ml |
| Taste | Marked pear aroma, | Flat aroma |
| description | same sweetness intensity, | late-onset sweetness, |
| | sweetness onset as sugar, | metallic off-taste, bitter |
| | persistent sweetness, no | aftertaste |
| | off-taste | |

### CONCLUSION

Using the inventive sweetener combination, various consumer expectations can be met considerably better than before. These are in detail:
no sugar addition necessary, thus reduced calories of the preserved fruits;
especially very good taste with respect to sweetness, particularly no bitter aftertaste;
imparts a typical fruit aroma; and
long storage stability, taste remaining the same over the entire storage period.

That which is claimed:

1. A sweetener mixture consisting of acesulfame-K and sucralose in a weight ratio, of acesulfame-K/sucralose ranging from 70/30 to 98/2, wherein said sweetener mixture imparts a fruit aroma to canned fruit.

2. The mixture as claimed in claim 1, wherein the mixture does not exhibit a bitter aftertaste.

3. The mixture as claimed in claim 1, wherein the weight ratio of acesulfame-K to sucralose is between 80/20 and 98/2.

4. The mixture as claimed in claim 1, wherein the weight ratio of acesulfame-K to sucralose is between 85/15 and 97/3.

5. The mixture as claimed in claim 1, wherein the weight ratio of acesulfame-K to sucralose is between 90/10 and 96/4.

6. The mixture as claimed in claim 1, wherein said mixture further includes one or more sweeteners selected from the group consisting of: cyclamate, saccharin and NHDC.

7. Canned fruit comprising fruit and a sweetener mixture consisting of acesulfame-K and sucralose wherein the weight ratio of acesulfame-K to sucralose, acesulfame-K/sucralose, ranges from 70/30 to 98/2 and said sweetener mixture imparts a fruit aroma to the canned fruit.

8. The canned fruit as claimed in claim 7, wherein the weight fraction of the sweetener mixture of the weight of the total canned fruit is 0.005% by weight to 0.1% by weight.

9. The canned fruit as claimed in claim 7, wherein the fruit is in a container made of metal, glass or plastic.

10. The canned fruit as claimed in claim 7, wherein the fruit is selected from one or more fruit varieties selected from the group consisting of pome fruit, stone fruit, berry fruit, tropical fruits, citrus fruits or wild fruits.

11. The canned fruit as claimed in claim 7, wherein the fruit comprises at least one of pineapple, apple, pear, peach, mandarin, and cherries.

12. Canned fruit as claimed in claim 7, wherein said canned fruit consists essentially of fruit in a make-up solution consisting essentially of
a sweetener mixture consisting of acesulfame-K and sucralose,
and, optionally, one or more of acids, antioxidants, thickeners, dyes or aroma substances,
wherein the weight ratio of acesulfame-K to sucralose, acesulfame-K/sucralose, ranges from 70/30 to 98/2.

13. A process for sweetening canned fruits, which comprises using the sweeteners acesulfame-K and sucralose in a weight ratio of acesulfame-K/sucralose ranging from 70/30 to 98/2, wherein said sweetener mixture imparts a fruit aroma to the canned fruit.

14. A process for sweetening canned fruits as claimed in claim 13, wherein said process further comprises reducing the sugar content in canned fruits by replacing a portion, or all, of the sugar which is added to the canned fruit by a sweetener mixture consisting of acesulfame-K and sucralose.

15. Fruit canning make-up solution comprising a mixture as claimed in claim 1.

16. A solution comprising a mixture as claimed in claim 1 and water.
